(19) United States
(12) Patent Application Publication
(10) Pub. No.: US 2009/0173250 A1
(43) Pub. Date: Jul. 9, 2009

(54) SYSTEM FOR PROTECTION AGAINST MISSILES

(75) Inventors: William Donnelly Marscher, Morristown, NJ (US); William Joseph Kelly, Montville, NJ (US); Paul James Guthrie, Newton, NJ (US); Joseph John DeLorenzo, Rockaway, NJ (US); George DeMassi, Parsippany, NJ (US)

Correspondence Address: GRAHAM CURTIN, P.A., 4 Headquarters Plaza, P.O. Box 1991, Morristown, NJ, 07962-1991, US

(73) Assignee: MECHANICAL SOLUTIONS INC., Whippany, NJ (US)

(21) Appl. No.: 12/058,003

(22) Filed: Mar. 28, 2008

Related U.S. Application Data
(60) Provisional application No. 60/908,806, filed on Mar. 29, 2007.

(51) Int. Cl. F42B 12/64; F42B 12/00; F41B 11/00; F42B 7/04; F42B 5/02; B64D 1/00

(52) U.S. Cl. 102/438; 102/439; 124/56; 102/448; 102/430; 89/1.1

(57) ABSTRACT

A system is disclosed for defeating enemy missiles and rockets, particularly rocket propelled grenades (RPG's). The first step is to identify the firing of a missile by the use of sensors that give the approximate distance and bearing of the incoming missile. A non-lethal cloud of pellets is then launched from the target, which can be a building or vehicle or the like, in the general direction of the missile. The pellets are housed in a series of warhead containers mounted at locations on the target in various orientations. The warheads are triggered to fire a low velocity cloud of pellets toward the incoming missile. The pellets then collide with the missile a certain distance away from the target causing premature detonation of the missile, and/or possible severe damage to the missile, and/or deflection of the missile, due to the relatively high velocity of the missile.

### CROSS-REFERENCE TO RELATED APPLICATIONS

This application claims the benefit of U.S. Application 60/908,806, filed Mar. 29, 2007, the contents of which are incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of contract No. N00014-06-C-0040 awarded by the Office of Naval Research.

### FIELD OF THE INVENTION

The present invention relates to a system for defeating enemy missiles and rockets generally, and more particularly to a system of generating a non-lethal cloud of projectiles or pellets intended to collide with an enemy missile to cause premature detonation of the missile, and/or possible severe damage to the missile, and/or deflection of the missile, due to the relatively high velocity of the missile.

### BACKGROUND

During the times of terrorism and war, various guided and unguided missiles have been used resulting in casualties. A system that protects structures, ground/air/sea vehicles, and the people inside them against missile attack could save the lives of military troops as well as civilians. A common unguided missile currently used is the rocket-propelled-grenade (RPG).

Existing technologies for RPG or missile defeat systems include application of slat armor to the military vehicles. The principle of slat armor is to stop the missile before it strikes the body of the target, to crush the missile and short circuit its electric fuze, or to cause shaped charge detonation at a standoff distance, rather than directly on the body of the vehicle. Disadvantages to slat armor are that it adds significant weight to the vehicle, and sacrifices maneuverability. Other RPG or missile defeat systems launch a single or small number of projectiles toward the incoming missile. These systems require accurate sensing of the missile trajectory, accurate aim of the projectiles in order to intercept the missile, and fast reaction time to slew and fire the projectile.

Another existing strategy for RPG defeat is to deploy a commercial air bag to trap the RPG before it strikes the vehicle. Still another is to deploy a net-shaped trap made of super high strength ballistic fiber. The net is claimed to defeat the RPG by crushing its ogive and rendering the fuze inoperable. Both the airbag and the net intercept the RPG at a standoff distance of up to two meters. At this standoff distance, the RPG shaped charge jet still has significant penetrating ability. Neither of these competing technologies prevents the detonation of the RPG by its built-in self-destruct mechanism, nor do they protect nearby personnel from shrapnel from the exploding RPG.

### SUMMARY

A system is disclosed for defeating enemy missiles and rockets, particularly rocket propelled grenades (RPG's). The first step is to identify the firing of a missile by the use of sensors that give the approximate distance and bearing of the incoming missile. A non-lethal cloud of projectiles or pellets is then launched from the target, which can be a building or vehicle or the like, in the general direction of the missile. The pellets are housed in a series of warhead containers mounted at locations on the target in various orientations. The warheads are triggered to fire a low velocity cloud of pellets toward the incoming missile. The pellets then collide with the missile a certain distance away from the target causing premature detonation of the missile, and/or possible severe damage to the missile, and/or deflection of the missile, due to the relatively high velocity of the missile.

In a preferred embodiment of the present disclosure, the system does not require highly accurate sensing of the incoming missile location, nor does it require slewing of a countermeasure weapon. This leads to increased potential for interception of missiles fired from very close range. The shot can be fired at non-lethal velocities, since the missile velocity will provide nearly all of the required impact energy. The present system preferably contains no high explosives or fuzes, which will lead to ease of transportability and implementation. Also, the system is preferably not lethal to people standing in the path of the shot when fired. The shot cloud system is relatively lightweight and easy to deploy. The result of the system is that the incoming missile will detonate prematurely before hitting its target and greatly reduce the resulting damage and loss of life. Appropriate density shot has also been demonstrated to limit the travel of shrapnel from the point of RPG detonation.

### BRIEF DESCRIPTION OF THE DRAWINGS

FIG. 1 illustrates a typical RPG.

FIG. 2 illustrates voltage output from RPG fuze due to pellet impact.

FIG. 3 illustrates a RPG ogive that has been damaged by the protective system of the invention.

FIG. 4A illustrates one embodiment of a pair of warheads for implementing the system of the present invention.

FIG. 4B illustrates one embodiment of a warhead of the invention attachable to a base.

FIG. 5 illustrates one embodiment of a section of a canister of the present invention.

FIG. 6 illustrates one embodiment of a warhead assembly of the present invention.

FIG. 7 illustrates one embodiment of electrical connections useful for operating the system of the present invention.

FIG. 8 illustrates clouds of pellets surrounding a target.

### DETAILED DESCRIPTION OF THE PREFERRED EMBODIMENTS

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

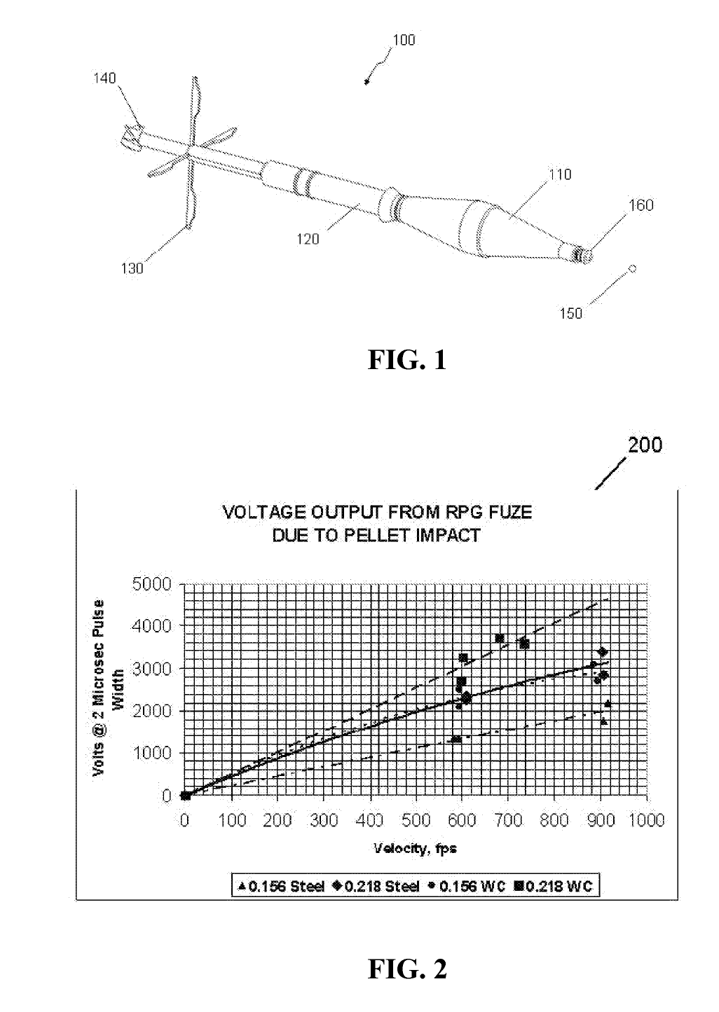

FIG. 1 illustrates one embodiment of a typical rocket-propelled grenade (RPG) 100 comprising an ogive 110, a sustainer motor 120, stabilizer fins 130, a rear offset fin 140 and a fuze 160. While an RPG is illustrated, it will be appreciated that the protective system of the present invention could be employed on any incoming enemy threat such as a missile, rocket, or the like. For purposes of convenience, the enemy threat will be described simply as an RPG.

The firing of the RPG 100 can be detected by various sensing means (not shown) including infrared (IR) sensors, radar and/or cameras. These sensors can be mounted on the potential target structure, which can be a vehicle or building, for determining approximate distance and bearing of the incoming RPG. Alternatively, sensors can be mounted separate from the target structure but in close proximity to the target structure if necessary. Alternatively, offsite or remote sensors could be utilized instead of, or in addition to onsite sensors, to improve the accuracy and/or tracking of the protective system of the present invention. Various sensor means could be employed as desired by the user and in accordance with appropriate field conditions.

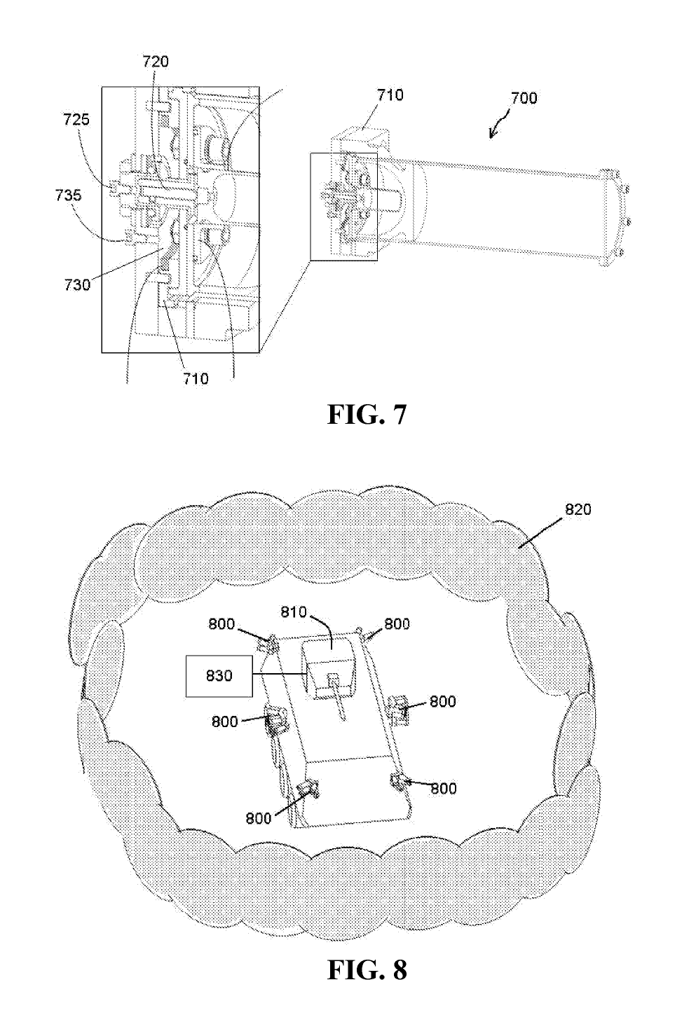

Sensors are used to trigger warhead devices (described in more detail below) mounted on a target or an adjacent location to produce a cloud or screen of projectiles or pellets (see FIG. 8) intended to engage and disable an incoming RPG. More preferably, a variety of warhead devices are mounted in strategic locations relative to the target so that the target is sufficiently protected through a surrounding screen of pellets that will allow up to the entire target structure to be protected. The warhead can be any device or combination of devices that will propel shot in a manner that will produce a cloud or screen of pellets 820 (see FIG. 8) distributed such that they have a significant probability of hitting an incoming RPG.

In one non-limiting example, warhead containers (to be described below) with tubular cross-sections of 40 mm to 100 mm were tested, although other dimensions will be operable. The tubes were filled to various depths with projectiles or pellets, which were discharged at varying velocities. The pellets were discharged with and without the aid of a pusher plate (to be described below). The shot dispersion angle at the muzzle of the tubes was measured using a high speed camera. Results of this testing are shown in Table 1.

TABLE 1
Dispersion Testing

| | | | Pusher | Dispersion |
|---|---|---|---|---|
| Tube Diameter, mm | Velocity, ft/s | Depth, in. | Plate | Angle |
| 40 | 60 | 3 | No | 38° |
| 40 | 80 | 6 | No | 37° |
| 40 | 60 | 12 | No | 31° |
| 40 | 75 | 3 | Yes | 34° |
| 40 | 95 | 6 | Yes | 34° |
| 40 | 100 | 12 | Yes | 24° |
| 100 | 60 | 2 | No | 45° |
| 100 | 90 | 4 | No | 59° |
| 100 | 55 | 2 | Yes | 45° |
| 100 | 65 | 4 | Yes | 53° |

Statistical calculations revealed that a dispersion angle of 30° or more resulted in a shot pattern that provides a high probability of impact with an incoming RPG. The use of a pusher plate resulted in a more even dispersion pattern, although other methods to achieve this are possible. Warhead shot containers with rectangular or elliptical cross-sections may also be used. Other cross-sectional configurations are contemplated. A wide range of organic and inorganic materials, including, but not limited to, reinforced plastic, polymeric composites, aluminum and steel, can be used for the shot containers. Other materials are contemplated.

A significant amount of testing was performed, using the RPG of FIG. 1, to establish size, shape, and material of the shot. Pellets 150 of various materials were fired in the laboratory at inert RPG grenades with piezoelectric fuzes 160, and fuze output voltages were measured. It was determined that suitably dimensioned pellets with a range of shapes, compositions and sizes can be used to pre-detonate the RPG. FIG. 2 (200) shows that both steel and tungsten carbide shot, preferably greater than 0.156 inch diameter, produced sufficient fuze output voltage and generated a sufficient voltage pulse in the RPG detonation fuze to pre-detonate an RPG if the impact was on the RPG fuze. Other shot materials evaluated include reactive particles, piezoelectric particles and triboelectric particles, where in one embodiment for example, the shot material is ejected to impart an electric charge to the body of the incoming threat so that its detonator prematurely activates. These particles react on impact with the RPG to defeat it by one of the mechanisms described above. Other materials are also contemplated.

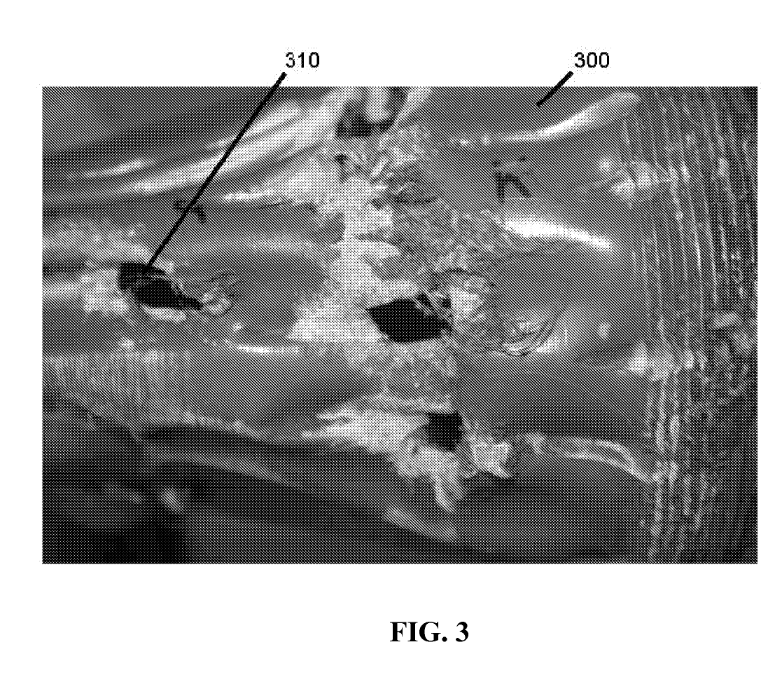

As shown in FIG. 3, an RPG ogive 300 can be significantly damaged by impact with the pellets. Both steel and tungsten carbide pellets were found to dent or penetrate the ogive 300, with other materials anticipated to have similar results. Pellets that penetrate the ogive can disrupt the shaped charge and reduce its lethal penetrating ability. Ogive dents and/or penetrations 310 can cause short circuiting of the electric detonation circuit (not shown) thereby causing the shaped charge not to actuate upon impact with the target. An observation during testing was that pellet impacts also have the potential for deflecting a RPG off course.

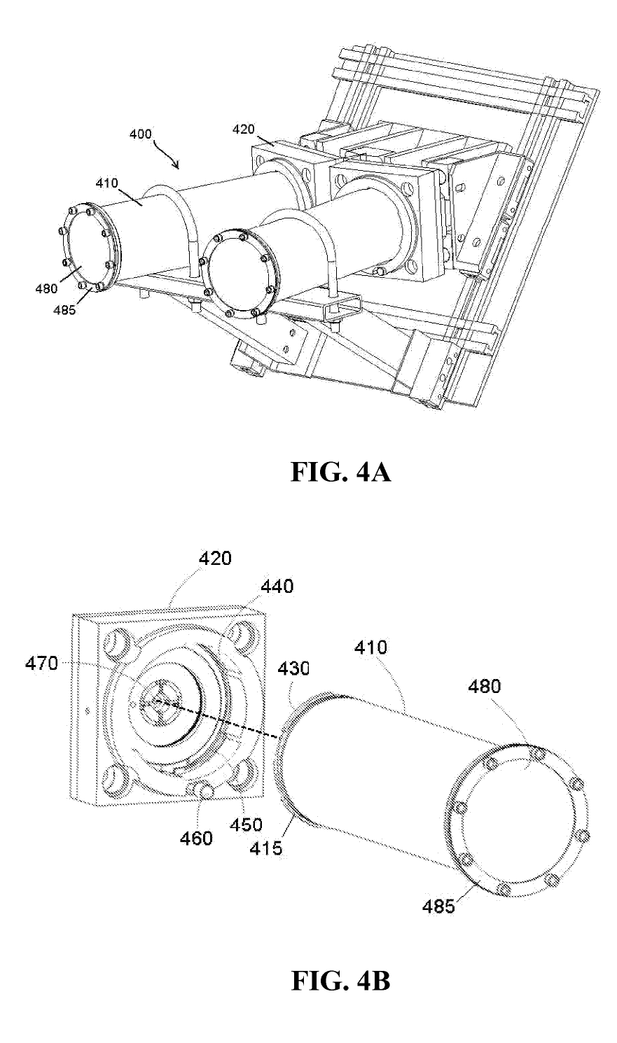

FIG. 4A illustrates a non-limiting embodiment of a pair of warhead shot containers 400 comprised of steel cylindrical tubes 410 mounted at its back ends 415 on bases 420 preferably having, as tested, an inside diameter of approximately 100 mm, a length of approximately 14 inches, and wall thickness of approximately 0.1 inches. While two containers are shown, it will be understood that only one container may be utilized, or more than two as the need or situation arises. Furthermore, while the containers are oriented in a consistent relationship, it will be understood that the other orientations are possible as long as there is no detrimental cross-fire.

As shown in FIG. 4B, a tube 410 is mounted at its back end 415 to a base 420 through the engagement of locking tabs 430 on the tube 410 with locking slots 440 on the base 420. A wave spring 450 is further provided on the base for biased contact between the tube 410 and base 420, while a locking pin 460 provides additional secured engagement at the junction of the tube 410 and base 420. A contact socket 470 in the base 420 allows for passage of the actuation mechanism that activates the warhead 400.

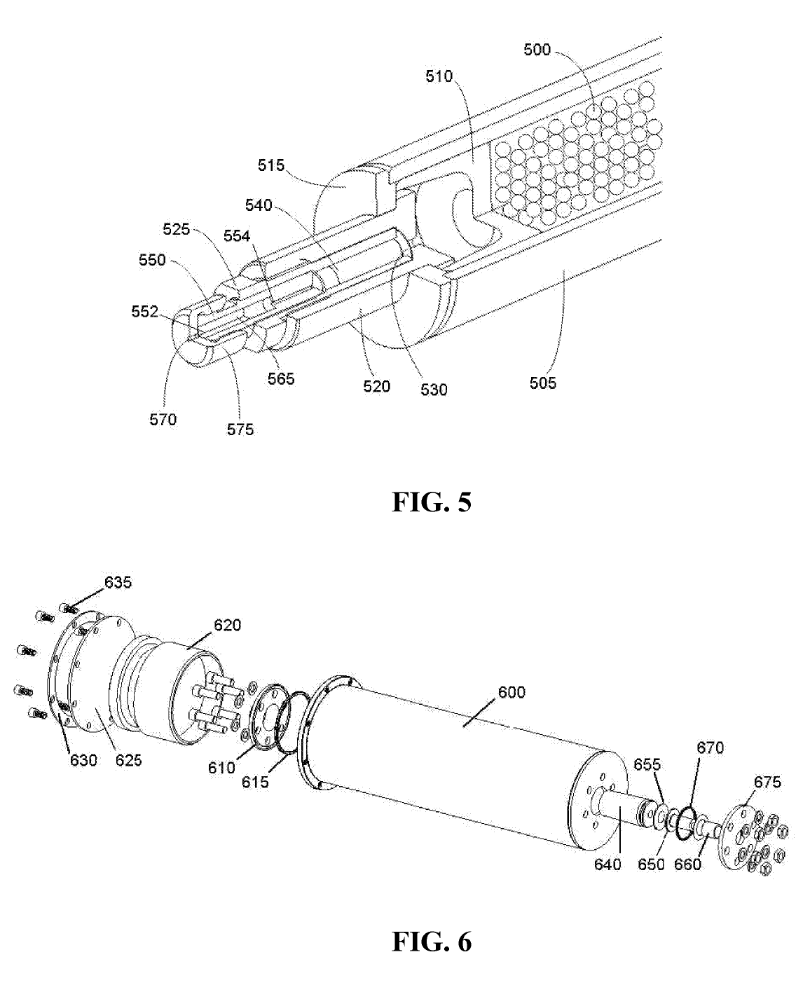

One embodiment of a proven design of a propulsion system at the back end 415 of a warhead 400 is shown in FIG. 5. The warheads 400 house pellets 500 and a pusher cup or plate 510. The pellets 500 are held in the warhead 400 preferably by a frangible or dislodgeable cover 480 (FIGS. 4A, 4B) secured, for example, by a plastic ring 485. Behind the pusher plate 510 is a cylindrical pressure chamber which will propel the pusher plate 510 and pellets 500 when sufficient pressure occurs. A high-low adapter 520 and a canister base 515 are welded to the preferably 100 mm canister 505. A high pressure 12-gauge insert 525, with a brass burst disk 530 in front of it, is threaded into the high-low adapter 520. A pyrotechnic mechanism such as a 12-gauge shotgun shell 540 with a pre-wired primer is inserted into the high pressure insert 525. A threaded rod 550, with a large axial hole 552 at the back and a small axial hole 554 at the front, is screwed into the high pressure insert 525 behind the shotgun shell 540. Primer wires 560 are threaded through the axial holes 552, 554 and attach to the shot gun shell 540. A grooved rubber plug 565 is inserted into the large axial hole 552, with the wires 560 in the groove. The wires 560 are threaded through the hole 570 in the threaded cap 575, which is then screwed onto the threaded rod 550. When electronically triggered, the propellant will ignite and will launch the pusher cup 510 and shot 500. This propulsion system was employed and performed successfully during live RPG testing. Other propulsion systems are possible, such as sheet explosives, which have the potential for warhead size and weight reduction.

Another embodiment of the proven design of a propulsion system useful in the present invention is shown in the warhead tube 600 of FIG. 6. A cartridge holder 610 and an O-ring seal 615 are bolted, with lock washers, on the inside of the warhead tube 600. A pusher plate 620 and pellets (not shown) are then placed in the tube 600 and held there by a frangible cap 625, secured to the tube 600 by a steel washer 630 and cap screws 635. A 20 mm cartridge 640 with an electric primer 645 and containing propellant (not shown) is inserted into the cartridge holder 610 at the back of the warhead and a metal contact bar 650, rubber washers 655, a plastic insulating sleeve 660, an O-ring 670 and a support plate 675 are attached. The metal contact bar 655 contacts the center of the primer in the cartridge 640. Rubber and plastic components insulate the contact bar 650 from the rest of the assembled warhead tube 600.

Another embodiment of a propulsion system useful in the present invention involves using a pneumatic assembly at the back of the warhead tube 600 comprising a pressurized cartridge and a fast acting release valve, wherein such propulsion system utilizes compressed air to propel the pellets.

In accordance with one embodiment of the present invention, two warheads 700 (only one being shown; see FIG. 4A that shows two) are then inserted into breech blocks 710 with electrical contacts as shown in FIG. 7. Specifically, the metal contact bar 720 on the warhead 700 contacts the positive electronic firing pin 725 in the breech block 710. The metal support ring 730 on the warhead 700 contacts the negative firing pin 735. When electronically triggered, the propellant will ignite and will launch the pusher cup and pellets.

In a preferred, non-limiting embodiment, for the RPG ogive identified in FIG. 3, for example, each warhead is filled with pellets made of tungsten carbide having a diameter of approximately 0.215 inches, a density of approximately 14.9 g/cm³, and a Rockwell C hardness of approximately 75. This configuration results in approximately 15,000 pellets housed in each warhead. Other shot configurations are contemplated. When triggered, the pellets are ejected from the two warheads in a non-directed manner and typically radiate as clouds with expanding circular cross-sections that progressively overlap. The pellets leave the warheads at speeds between 50 ft/s and 150 ft/s, and more preferably at speeds that are non-lethal to nearby personnel. In this example implementation, the pellets will have a dispersion angle of approximately 40 degrees radiating from each warhead tube, and an overall dispersion angle from a pair of warhead tubes of approximately 60 degrees. This configuration using a large number of pellets will result in a high probability of encountering the piezoelectric device on the nose of the missile, and thereby causing premature detonation of the missile. This was confirmed by testing one described typical embodiment system against several separate live RPGs fired from an RPG launcher. The RPGs that entered the protected area of the screen all detonated upon impact with the pellets.

As shown in FIG. 8, a series of warheads 800 can be mounted on a vehicle 810 and can protect the vehicle 810 from missile attack. Any structure can be provided with complete coverage by proper placement and orientation of a series of warhead tubes. In the typical embodiment, the shot screen 820 is fired in order to strike the missile 10 to 20 feet from the target vehicle or building. Once the sensor 830 detects that a missile has been fired, the speed and approximate trajectory of the missile must also be determined by measurement, typically supported by rapid calculation. Calculations are made to determine if, when and approximately where the missile will strike the vehicle or building, therefore determining which warhead tubes must be fired, and when they need to be fired. This will require a distributed or central processing unit (not shown) that is capable of collecting data from the sensors and making the appropriate calculations. It should be noted that, in the preferred embodiment, the warhead tubes are mounted statically and are not slewed. The result is an automatic system capable of defeating multiple missiles and thereby protecting vehicles, buildings, and people.

The shot is preferably fired at non-lethal velocities, since the missile velocity will provide nearly all of the required impact energy. The present system preferably contains no high explosives or fuzes, which will lead to ease of transportability and implementation. Also, the system is preferably not lethal to people standing in the path of the shot when fired. The shot cloud system is relatively lightweight and easy to deploy. The result of the system is that the incoming missile will detonate prematurely before hitting its target and greatly reduce the resulting damage and loss of life.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

We claim:

1. A system for protecting a target against an incoming threat, comprising:
a. a sensor for sensing information about an incoming threat;
b. at least one container further comprising a plurality of projectiles; and
c. a propulsion system that ejects the plurality of projectiles from the at least one container, based on information obtained from the sensor;
d. wherein the plurality of projectiles are ejected to intercept the incoming threat for purposes of disabling the incoming threat prior to impact with the target; and
e. wherein the plurality of projectiles are ejected at a velocity that is not lethal to nearby personnel.

2. The system of claim 1, where the plurality of projectiles is ejected to form a cloud of projectiles that is distributed to increase the probability of impacting the incoming threat.

3. The system of claim 1, wherein the ejection of the plurality of projectiles is not slewed.

4. The system of claim 1, wherein the plurality of projectiles are ejected to prematurely detonate the incoming threat.

5. The system of claim 1, wherein the plurality of projectiles are ejected to penetrate an outer surface of the incoming threat.

6. The system of claim 1, wherein the plurality of projectiles are ejected to redirect the orientation of the incoming threat so that it is no longer a threat to the target.

7. The system of claim 1, wherein the plurality of projectiles are ejected to impart an electric charge to the body of the incoming threat so that its detonator prematurely activates.

8. The system of claim 2, further comprising a plurality of containers mounted on the target for creating multiple clouds of ejected projectiles.

9. The system of claim 1, wherein the projectiles further comprise one or more pellets formed from a range of materials comprising steel, tungsten carbide, tungsten alloys, reactive particles, piezoelectric particles and triboelectric particles.

10. The system of claim 1, wherein the propulsion system utilizes compressed air to propel the projectiles.

11. The system of claim 1, wherein the propulsion system utilizes a pyrotechnic mechanism.

12. The system of claim 11, wherein the propulsion system is fuzeless.

13. The system of claim 12, wherein the propulsion system further comprises a shotgun shell and a pusher plate for ejecting the projectiles from the container.

14. The system of claim 1, wherein the container further comprises a frangible or dislodgeable cover that keeps the projectiles in the container prior to ejection.

15. The system of claim 1, wherein the velocity is between 50 ft/sec and 150 ft/sec.

16. The system of claim 15, wherein the plurality of projectiles are ejected with a dispersion angle of at least around 30 degrees.

17. A system for protecting a target against an incoming threat having a detonation fuze, comprising:
a. at least one container further comprising a plurality of projectiles; and
b. a propulsion system that ejects the plurality of projectiles from at least one container to intercept the incoming threat for purposes of disabling the incoming threat prior to impact with the target;
c. wherein the plurality of projectiles are suitably dimensioned such that when one or more of the projectiles impacts the detonation fuze on the incoming threat it generates a sufficient voltage pulse in the detonation fuze for purposes of pre-detonating the incoming threat prior to contact with the target.

18. The system of claim 17, wherein a projectile of the plurality is greater than 0.156 inches in diameter.

19. The system of claim 18, wherein the plurality of projectiles further comprises one of steel, tungsten carbide, or tungsten alloy pellets or reactive particles.

20. A method of protecting a target against an incoming threat comprising:
a. sensing the incoming threat; and
b. ejecting a plurality of projectiles from the target along a path to form a cloud of projectiles that is intended to be impacted by the incoming threat for purposes of disabling the incoming threat prior to impact with the target;
c. wherein the plurality of projectiles are ejected at a velocity that is not lethal to people in the path.

21. The method of claim 20, further comprising ejecting the plurality of projectiles in a non-directed manner from one or more containers mounted on the target.

22. The method of claim 21, wherein the velocity is between 50 ft/sec and 150 ft/sec.
